(19) United States
(12) Patent Application Publication
(10) Pub. No.: US 2014/0250782 A1
(43) Pub. Date: Sep. 11, 2014

(54) Roof Growth System

(71) Applicants: Cornelis Frans Taco Visser, 'S-Gravendeel (NL); Andries Van Der Stoel, Dordrecht (NL)

(72) Inventors: Cornelis Frans Taco Visser, 'S-Gravendeel (NL); Andries Van Der Stoel, Dordrecht (NL)

(73) Assignee: VISSER 'S-GRAVENDEEL HOLDING B.V., 's-Gravendeel (NL)

(21) Appl. No.: 14/233,659

(22) PCT Filed: Jul. 19, 2012
(86) PCT No.: PCT/NL2012/000055

§ 371 Date: May 21, 2014

(30) Foreign Application Priority Data
Jul. 19, 2011 (NL) 2007142

(51) Int. Cl. A01G 9/02

(52) U.S. Cl. CPC A01G 9/02
USPC 47/65.9

(57) ABSTRACT

The present invention relates to a roof growth system, comprising: at least one holder-like container (6) for placing on a roof (3, 5) and having a growth substrate (18) therein during use; a connection (11, 12) for arranging the container on the roof at least during use, further comprising: at least one conduit (17) to be connected at least to a liquid source; and an irrigation (8) which is associated with the holder-like container and which can be connected at least to the conduit, wherein the connection comprises an engagement (22, 23) formed on or between an outer side of a side wall of the container and the conduit.

The present invention relates to a roof growth system, comprising at least one holder-like container for placing on a roof and having a growth substrate therein during use, and a connection for arranging the container on the roof at least during use.

Such systems are known, for instance from FR-2,929,632, wherein cables from which containers are suspended are applied as connection to for instance a sloping roof. U.S. Pat. No. 6,606,823 further discloses a system with an integrated irrigation.

The known systems have drawbacks. Containers suspended from cables as according to FR-2,929,632 can thus be susceptible to wind when it blows under the containers, and the containers can be detached from the roof and/or begin to rattle thereon. The roofs are then possibly not designed for the forces then exerted by the containers on these roofs. It is noted in this respect that known containers comprise excess space so as to be able to contain a reserve of (rain)water in order to prevent withering of the vegetation in the containers. Usually taken into account here is that the weight of containers remains below the load-bearing capacity of the roofs (and often only a little below this load-bearing capacity), but in the case of heavy rain or a layer of snow the weight of the combination of the rain that has fallen or the layer of snow and the containers is nevertheless often greater than the load-bearing capacity of the roof. In order to prevent problems caused for instance by collapsing roofs, roofs have to be reinforced for the purpose of placing a known system for roof growth thereon. There is therefore a need for lighter containers, although these are more susceptible to the influences of wind. Weighting the connection in order to better immobilize the containers on the roof meets with the same problem, that the load on the roof by the containers and the weighted connection (compared to the known cables) can become too high even more quickly in determined conditions such as heavy rain or snowfall.

According to U.S. Pat. No. 6,606,823 irrigation can be applied and adjacent containers or trays can on the one hand be coupled at a distance with dovetail connections on which conduits can be laid or mounted, or on the other be coupled close-fittingly and be placed loosely on conduits.

The present invention aims to obviate or at least reduce, preferably considerably, the above stated and/or other problems of the known systems, for which purpose a system according to the invention is provided which is distinguished from the known system by at least one conduit to be connected at least to a liquid source; and by an irrigation which is associated with the holder-like container and which can be connected at least to the conduit. The system according to the invention must further have the feature that the connection comprises an engagement formed on or between an outer side of a side wall of the container and the conduit. The system can thus be further simplified in the sense that separate mounting planks or slats can be dispensed with and mounting of the containers can take place using the conduit(s). The system can further have the feature here that the conduit can be fixed at least to the roof and the engagement comprises at least one edge or flange on at least one of the container and the conduit. This produces a hooking system which is very simple to mount and wherein the edge or flange can hook or at least engage on, behind, in or at the other of the conduit and the container in order to immobilize the container and the conduit relative to each other. A mounting slat is preferably provided which can be mounted at least on the roof during use, wherein the edge or flange is arranged on the container and in mounted state hooks into or on the mounting slat. As noted, the mounting slat can also form the conduit (and vice versa).

In a system according to the invention the water reserve can be decreased, whereby the weight of the containers can be minimized. The reduction in weight is surprisingly even such that according to the invention a much more adequate connection (than only a cable in the known system) has become possible in order to secure the containers on the roof, this without any imminent danger of rainfall or snowfall compromising the load-bearing capacity of an associated roof.

In an embodiment the system according to the invention can have the feature that the irrigation comprises at least one sprinkler head. Such a sprinkler head can sprinkle a plurality of containers. In an additional or alternative embodiment the system according to the invention can have the feature that the irrigation comprises at least one dripper. The system can have the feature here that the dripper comprises a flexible conduit in or through the container.

In an additional or alternative embodiment the system according to the invention can have the feature of at least two containers and at least one coupling for coupling the at least two containers in close connection. Combinations of containers can thus almost wholly cover the roof involved, and collect all precipitation and thus contribute toward the water-tightness of the roof and also reduce the irrigation requirement, while the irrigation per se minimizes the need for sizeable precipitation reservoirs in the containers. The system can have the further feature here that at least one of the two containers comprises an overhang having therein or thereon at least a part of the coupling, with a cavity under the overhang in which the conduit is accommodated. The conduit can thus be provided in space-saving manner in order to maximize covering of the roof with containers.

In an additional or alternative embodiment the system according to the invention can have the feature that the holder-like container comprises a side wall diverging upward and outward from the bottom thereof. Conduits and/or mounting planks or slats can be accommodated easily and efficiently in thus formed spaces between containers.

In an additional or alternative embodiment the system according to the invention can have the feature that at least one of a bottom of the container and a side wall extending from the bottom of the container comprises a break-off piece for passage of the dripper and connection thereof to the conduit. Such a break-off piece preferably has a peripheral form closely corresponding to the peripheral form of for instance a sprinkler head and/or dripper in order to realize as closed a surface as possible on top of the roof, which can contribute toward the moisture-tightness of the roof as a whole.

In an additional or alternative embodiment the system according to the invention can have the feature that a bottom of the holder-like container comprises at least one elongate elevation for receiving along the bottom at least one carrier, for instance a fork of a forklift truck. Such an elevation can serve to enclose a fork of a forklift truck, for instance during assembly of a system according to the invention on a roof, but can also serve to accommodate conduits and/or mounting planks or slats in such a system in the assembled form.

In an additional or alternative embodiment the system according to the invention can have the feature that a bottom of the holder-like container comprises at least one elevation with holes for draining excess liquid. A limited reservoir can thus be realized despite the provided irrigation.

In an additional or alternative embodiment the system according to the invention can have the feature that inner dimensions of the holder-like container are dimensioned for receiving close-fittingly therein at least one tray of standardized dimensions. It is thus possible to place separate insert trays with clamp fitting in the container and so be able to grow several plants. The insert trays are easy to replace, possibly with different vegetation in each case.

In an additional or alternative embodiment the system according to the invention can have the feature that the growth substrate comprises:

a layer of particulate material such as gravel and/or chippings on the bottom of the holder-like container;

a separating layer on the layer of particulate material, for instance a layer of a fleece material and/or root barrier; and

a growth layer comprising for instance earth and/or coco fibre and/or glasswool and/or rockwool. The space occupied by the particulate material can serve as liquid buffer, the intermediate layer can limit root growth to the volume of the container located thereabove, in which space the growth layer of earth or the like is situated. A complete system is thus provided.

It is noted that the present invention otherwise also relates per se to containers and conduits such as are evidently intended, designed and suitable for use in a system according to the present invention.

Following the foregoing general indication of the specific properties of a system according to the present invention, a specific embodiment will be described hereinbelow on the basis of the accompanying drawing, which is in no way intended or should be interpreted as limiting the scope of protection defined in the claims, and in which the same reference numerals are applied for the same or similar parts, components and aspects, and in which:

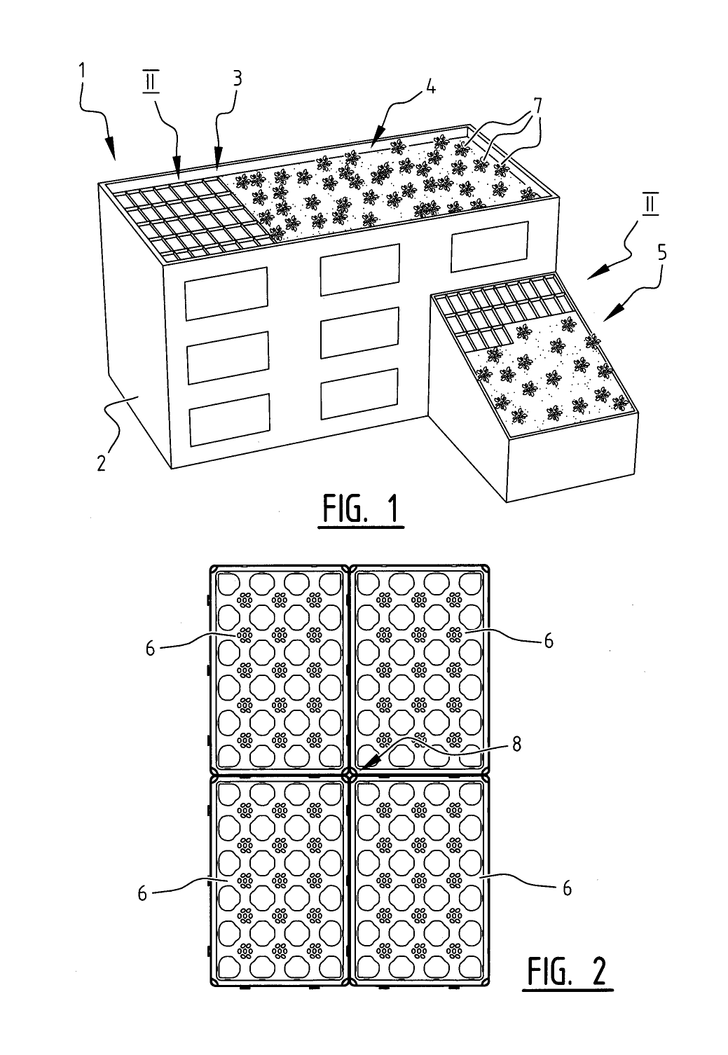

FIG. 1 is a perspective view of a building with a roof and with a system for roof growth according to the present invention;

FIG. 2 is a top view according to arrow II in FIG. 1;

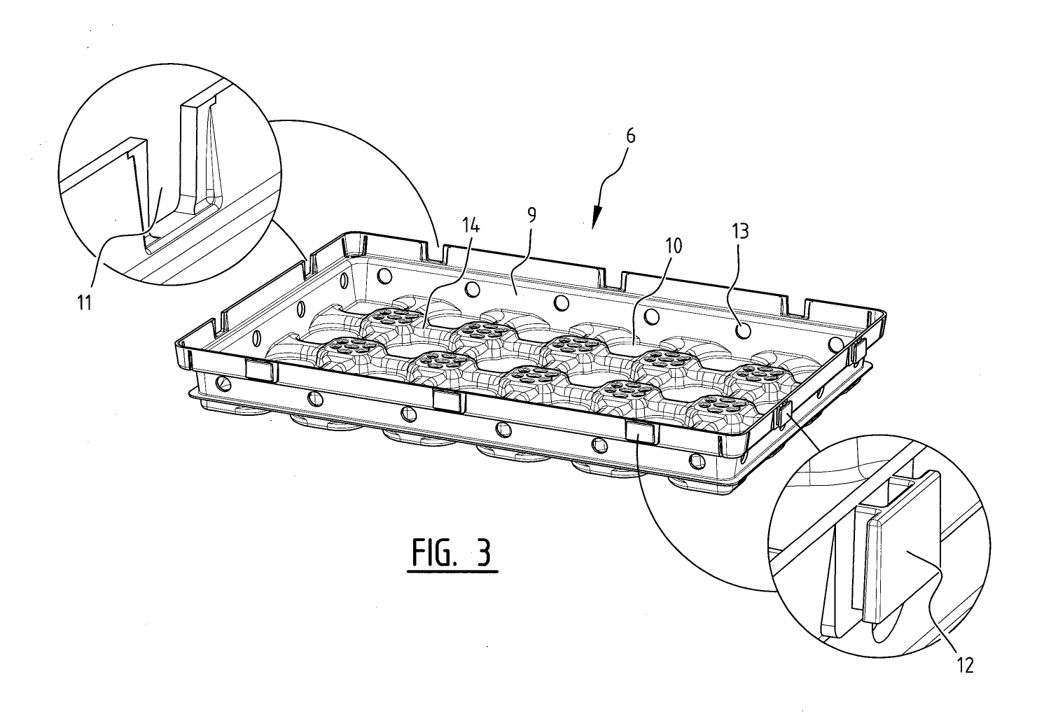

FIG. 3 is a perspective view of a container of the system according to FIG. 1 with fuller details thereof;

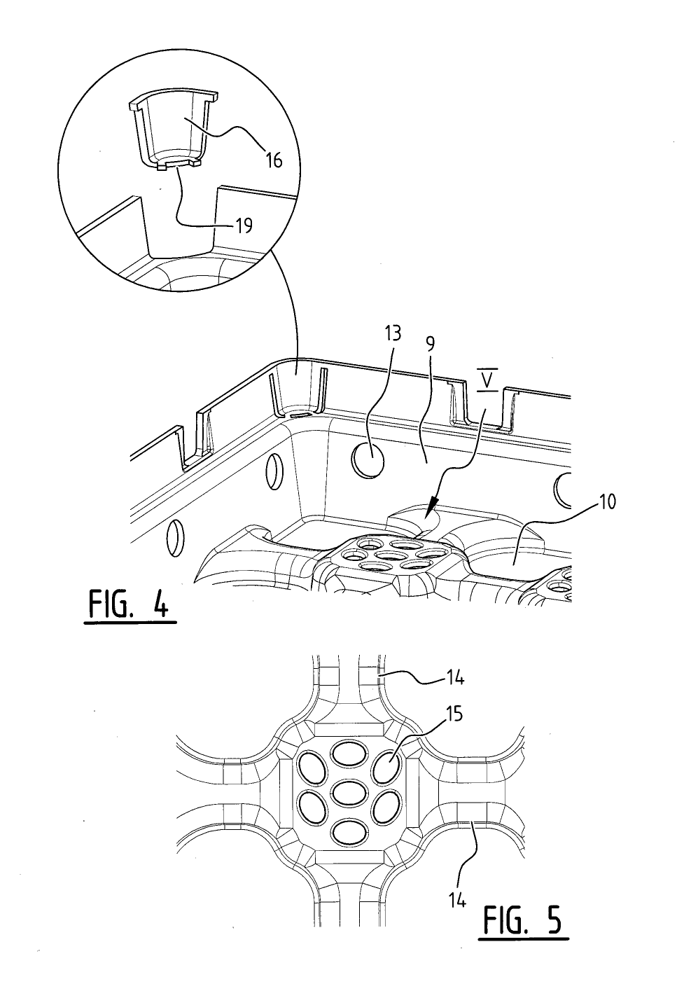

FIG. 4 is a perspective view of part of a container of the system according to FIG. 1 with a fuller detail thereof;

FIG. 5 is a top view according to arrow V in FIG. 4;

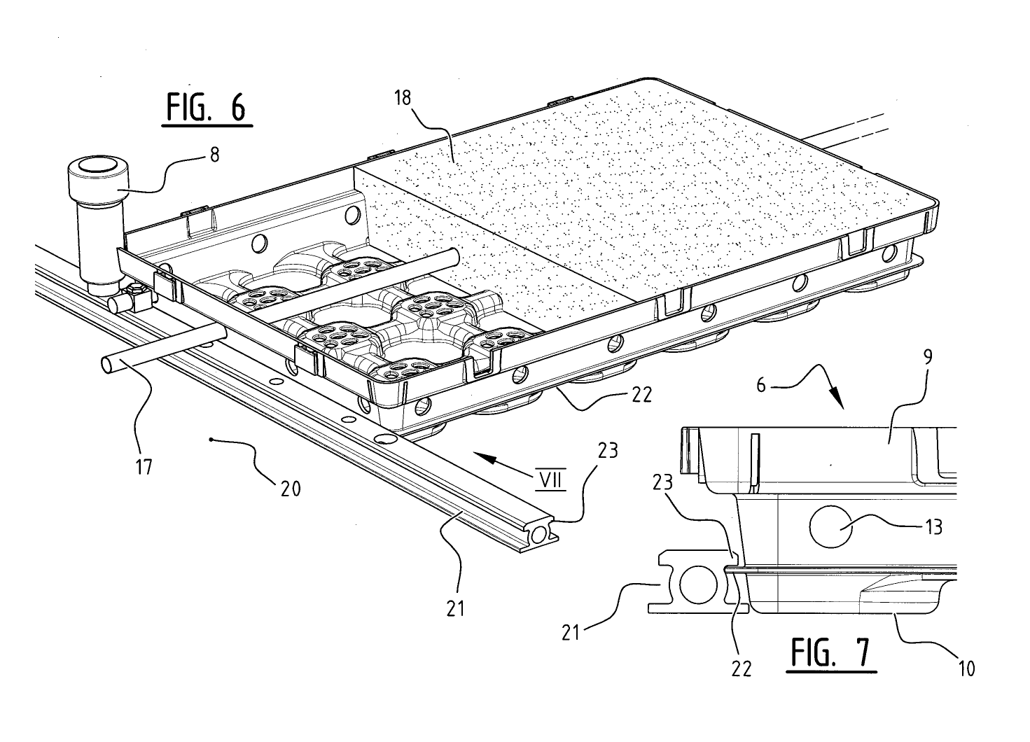

FIG. 6 is a detailed perspective view of a container during use in a system according to the present invention;

FIG. 7 is a side view according to arrow VII in FIG. 6;

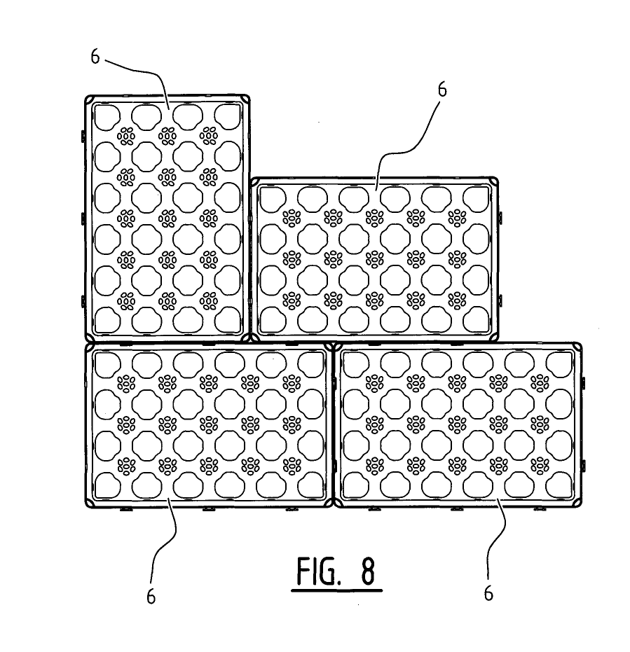

FIG. 8 shows an alternative arrangement relative to FIG. 2 of containers in a system according to the present invention;

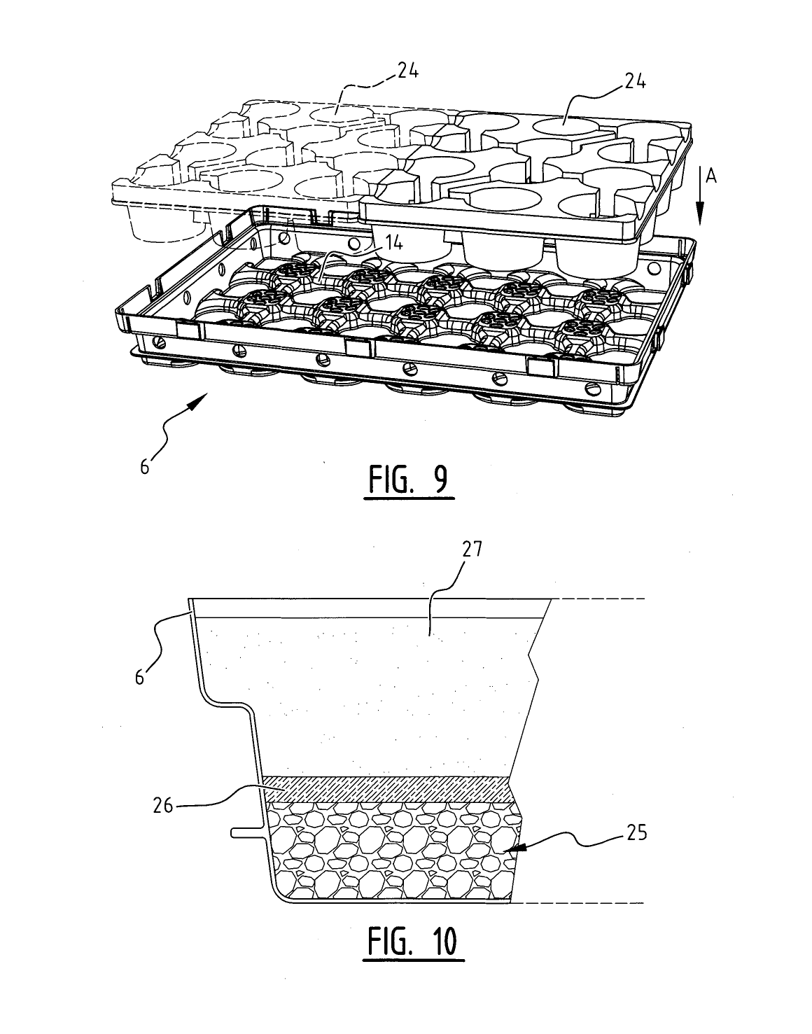

FIG. 9 is a perspective view of a container with additional insert trays according to the invention; and

FIG. 10 is a side view in vertical section of a filled container 6 during use.

FIG. 1 shows a building 1. Building 1 has side walls 2 which support a roof 3. Roof 3 is covered with a system 4 according to the present invention. Building 1 has a system 4 according to the present invention on the flat roof of a main building and the sloping roof 5 of an annexe. FIG. 2 is a top view of a part of a system 4 according to the present invention during use (indicated with arrow II in FIG. 1). In FIG. 2 this is an assembly of four containers 6 without substrate or vegetation. Plants are shown in FIG. 1 by way of example of a form of vegetation. An alternative could be a grass cover or shrubs and so on.

The assembly of four containers 6 in FIG. 2 represents only a part of the overall number of containers which may be required to cover a flat roof 3 or a sloping roof 5 of building 1. Containers 6 are mutually coupled in a manner further described below and in the centre of the combination of four containers 6 shown in FIG. 2 is provided a sprinkler head 8, likewise in a manner further described below.

The containers can have a upright side walls, i.e.

perpendicular to the bottom thereof.

As shown in FIG. 3 however, side walls 9 take a diverging form relative to bottom 10 of the holder-like container 6 in FIG. 3. Formed along one of the long sides and one of the short sides are recesses 11 into which engage coupling plates along the other of the long sides and the short side of an adjacent container 6. Recesses 11 and coupling plates 12 together form couplings between or of adjacent containers 6. Also arranged in side walls 9 of container 6 are passages 13 through which hoses or conduits can extend, preferably through a growth substrate in container 6. Such hoses or conduits (not shown in FIG. 3) for instance form part of a dripper, wherein dripper elements can draw from such hoses or conduits through the openings or holes 13 in side walls 9 of the containers.

Using the couplings formed by recesses 11 and coupling plates 12 it is possible to place adjacent containers 6 connecting closely against each other during assembly of individual containers 6 on a roof as shown in FIG. 1. It is thus possible to ensure that as much precipitation as possible enters containers 6. Also realized here is that the roof itself with containers 6 thereon is already made as watertight as possible with containers 6, which can contribute toward the lifespan of the roof.

When however a bottom 10 of containers 6 is articulated as shown in FIG. 3 or FIG. 5, the bottom comprises elevations 14 with drain holes 15 which provide for drainage of an excess quantity of liquid, in particular rainwater or other precipitation, when the level thereof rises above the level of elevations 14. Such elevations 14, which are elongate, simultaneously form passages under containers 6 for receiving therein or thereunder forks (not shown) of for instance a forklift truck. It is also possible to arrange conduits, for instance for the irrigation system, under these elevations 14. For displacement of containers 6 forks of a forklift truck can also engage on (preferably under) flange 22 (see below) or the shoulder in the outer side of the upward diverging form of the side wall of container 6.

In addition, it is also possible to make use of the configuration shown in perspective view in FIG. 4, where use is made of break-off corners 16 on the upper side of the diverging side walls 9 of containers 6. Such break-off corners 16 have a shape closely corresponding to an outer peripheral form of a sprinkler head 8 as shown in more detail in FIG. 1 and in FIG. 6. Once four break-off corners 16 of FIG. 4 of adjacent containers 6 have been broken away, a passage is provided for a sprinkler head 8 as shown in FIG. 6, wherein individual containers 6 connect closely to (a quarter part of) the peripheral form of sprinkler head 8. The use of a sprinkler head 8 does not prevent the possibility of conduits or hoses also being arranged through a growth substrate 18 in containers 6, as shown in FIG. 6. The sprinkler head sprinkles liquid, in particular water, over a number of adjacent containers, while the hose or conduit 17 can extend through diverse containers 6 in order to administer water or other liquid very locally, for instance using a dripper element (not shown) which can be connected to such a hose or conduit 17.

Break-off corner 16 has an edge 19 which is directed inward relative to container 6 and the peripheral form of which corresponds to a quarter part of the peripheral form of sprinkler head 8. The break-off or breakaway corners can be applied even when conduits 21 play no part in assembling of the system, such as the assembly described below with reference to FIG. 6 and FIG. 7.

As shown in FIG. 6 and FIG. 7, a conduit 21 which is connected or can be connected to a liquid source (not shown) is arranged over roof 20. Sprinkler head 8 is connected directly to conduit 21, whereby conduit 21 forms a supply for the irrigation in the form of sprinkler head 8 or the hose or conduit 17 forming part of a dripper system.

The form of the side walls 9 diverging away from the bottom 10 of container 6 makes it possible for parts of side walls 9 to overhang conduit 21. The couplings 11,12 between the adjacent containers 6 close over conduit 21. Containers 6 at the same time comprise a flange 22 round the periphery thereof. Such a flange can also be arranged at selected locations instead of all the way around container 6. In the assembled state of the system according to the present invention flange 22 protrudes below an edge 23 on the upper side of conduit 21. FIG. 7 shows how flange 22 on container 6 protrudes below edge 23 on conduit 21. Containers 6 can in this way be immobilized on the roof without separate mounting planks or slats needing to be used, since conduits 21 comprise the edges 23 below which the flanges 22 on containers 6 can be accommodated. Conduits 21 are mounted on roof 20 using separate means such as adhesive, screwing means or in other manner. The containers can be pushed against each other with flanges 22 below edges 23 during assembly of the system according to the present invention, wherein a container 6 is coupled in each case by means of couplings 11,12 to an adjacent container 6, the flange 22 of which has already been (at least partially) placed below an edge 23 of conduit 21. A series of containers can thus be coupled and subsequently pushed further with the flanges 22 extending below edges 23. Once the individual containers 6 have in this way reached a desired position, the break-off corners 16 can be broken away from the containers where a sprinkler head 8 has to be placed. Sprinkler head 8 can then be connected directly to conduit 21, for instance using a rapid-action coupling or by screwing sprinkler head 8 into conduits 21 so as to thus bring about a connection between sprinkler head 8 and the interior of conduit 21 to enable spraying or sprinkling of the substrate 18 in containers 6, wherein conduits or hoses 17 serve the same purpose and can likewise be coupled in a manner self-evident to the skilled person to the interior of conduits 21 in order to provide a dripper.

Shown in FIG. 9 is that inner dimensions of the holder-like container 6 are dimensioned for the purpose of close-fittingly receiving therein at least one tray 24 of standardized dimensions. Two insert trays 24 fit into the container, although this can be limited to one insert tray 24 or a random number higher than two. Such an embodiment can be applied even when no conduits and irrigation are provided.

FIG. 10 shows a cross-section of a filled container 6 during use. The growth substrate comprises a number of layers here: a layer of particulate material such as gravel 25 and/or chippings on the bottom of the holder-like container; a separating layer on the layer of particulate material, for instance a layer of a fleece material 26 and/or root barrier; and a growth layer comprising for instance earth 27 and/or coco fibre and/or glasswool and/or rockwool.

After examination of the foregoing disclosure of the present invention many alternative and additional embodiments will occur to the skilled person. All separate components, elements and properties can be combined, for instance a gravel layer on the bottom of the holder-like container having thereon an insert tray of standardized dimensions or, conversely, a layer of earth on the bottom with the insert tray thereon, or fleece layer 26 of FIG. 10 can be omitted so that gravel 25 and earth 27 remain. It is thus further possible for only one of the sprinkler head 8 and the dripper 17 to be implemented, and not both. Mounting planks or slats can also be applied instead of the multifunctional conduits 21 for the purpose of immobilizing the containers on the roof. The bottom need not necessarily comprise the elevations 14, although these can usefully serve to accommodate forks of a forklift truck, for instance during assembly of the system according to the invention. Providing an overflow in the form of the openings, passages or holes 15 in elevations 14 is not per se necessary, and containers 6 can also comprise an overflow system between one another, for instance mutual connections via holes 13, in order to avoid too high a reserve of (rain)water in containers 6.

FIG. 2 shows how containers 6 can engage together. FIG. 8 shows an alternative wherein containers 6 are coupled in offset manner, thereby providing an even stronger mutual connection. Couplings 11,12 are positioned such that such an offset connection or coupling of containers 6 is possible. In such an embodiment a break-off piece for one of three adjacent containers 6 will preferably have to follow half the periphery of the sprinkler head in order to make the containers 6 in combination with the sprinkler head as close-fitting as possible, or at least place them in the closest possible connection.

The system according to the present invention can be applied on flat roofs and sloping roofs, wherein immobilization of containers 6 is optimized while the amount of space for a reserve supply of liquid or water is minimized by applying irrigation, which is supplied through conduits 21, even if mounting slats or other elements are applied to immobilize containers 6 on the roof. The containers need not necessarily comprise elevations 14, although these can be useful for the purpose of defining an overflow in association with the openings or holes 15 and/or in respect of accommodating forks of forklift trucks for the purpose of manipulating the containers during or prior to assembly of a system according to the present invention. The above stated additional and alternative embodiments are also not in any way intended, and should not in any way be interpreted as such, as being limitative for the present invention, which is limited only to the scope of protection as defined in the appended claims, in particular the independent claims.

1. A roof growth system, comprising:
at least one holder-like container for placing on a roof and having a growth substrate therein during use;
a connection for arranging the holder-like container on the roof at least during use, with the connection comprising an engagement formed on or between an outer side of a side wall of the holder-like container and at least one conduit, which is to be connected at least to a liquid source; and
an irrigation which is associated with the holder-like container and is adapted to be connected at least to the at least one conduit,
wherein the at least one conduit is adapted to be fixed at least to the roof, and
wherein the engagement comprises at least one edge or flange on at least one of the holder-like container and the conduit.

2. A roof growth system, comprising:
at least one holder-like container for placing on a roof and having a growth substrate therein during use;
a connection for arranging the holder-like container on the roof at least during use, with the connection comprising an engagement formed on or between an outer side of a side wall of the holder-like container and at least one conduit, which is to be connected at least to a liquid source; and
an irrigation which is associated with the holder-like container and is adapted to be connected at least to the at least one conduit,
further comprising a mounting slat which is adapted to be mounted at least on the roof during use, wherein an edge or flange is arranged on the holder-like container and in a mounted state hooks into or on the mounting slat.

3. The system of claim 1, wherein the irrigation comprises at least one of at least one sprinkler head and at least one dripper.

4. The system as claimed in at least a foregoing claim, wherein the irrigation comprises at least one dripper.

5. The system of claim 1, wherein the conduit comprises a flexible conduit in or through the holder-like container.

6. The system of claim 1, comprising at least two holder-like containers and at least one coupling for coupling the at least two holder-like containers in close connection, wherein at least one of the at least two holder-like containers comprises an overhang having therein or thereon at least a part of the coupling, with a cavity under the overhang in which the conduit is accommodated.

7. The system of claim 1 wherein the holder-lie container comprises a side wall diverging upward and outward from the bottom thereof.

8. The system of claim 1 wherein at least one of a bottom of the holder-like container and a side wall extending from the bottom of the holder-like container comprises a break-off piece for passage of at least a portion of the irrigation and for connection thereof to the conduit.

9. The system of claim 1, wherein a bottom of the holder-like container comprises at least one elongate elevation for receiving at least one carrier.

10. The system, wherein a bottom of the holder-like container comprises at least one elevation (14) with holes (15) for draining excess liquid.

11. The system of claim 1, wherein inner dimensions of the holder-like container are adapted to receive close-fittingly therein at least one insert tray of standardized dimensions, and wherein the system further comprises the at least one insert tray.

12. The system of claim 1, wherein the growth substrate comprises:
a layer of particulate material on a bottom of the holder-like container;
a separating layer on the layer of particulate material; and
a growth layer positioned over the separating layer.

13. A holder-like container for use in the system of claim 1.

14. A conduit which in use forms part of a system as claimed in at least one of the foregoing claims 1-13.

15. The system of claim 12, wherein the particulate layer comprises gravel or chippings, or a combination of gravel and chippings;
wherein the separating layer comprises a fleece material or root material, or a combination of fleece material and root material; and
wherein the growth layer comprises one or more materials selected from a group consisting of earth, coco fibre, glass wool, and rock wool.

16. The system of claim 2, wherein at least one of a bottom of the holder-like container and a side wall extending from the bottom of the holder-like container comprises a break-off piece for passage of at least a portion of the irrigation and for connection thereof to the conduit.

17. The system of claim 2, wherein the irrigation comprises at least one of at least one sprinkler head and at least one dripper.

18. The system of claim 2, wherein the conduit comprises a flexible conduit in or through the holder-like container.

19. The system of claim 2, comprising at least two holder-like containers and at least one coupling for coupling the at least two holder-like containers in close connection, wherein at least one of the at least two holder-like containers comprises an overhang having therein or thereon at least a part of the coupling, with a cavity under the overhang in which the conduit is accommodated.

20. The system of claim 2, wherein the holder-like container comprises a side wall diverging upward and outward from the bottom thereof.

21. The system of claim 2, wherein at least one of a bottom of the holder-like container and a side wall extending from the bottom of the holder-like container comprises a break-off piece for passage of at least a portion of the irrigation and for connection thereof to the conduit.

22. The system of claim 2, wherein a bottom of the holder-like container comprises at least one elongate elevation for receiving at least one carrier.

23. The system of claim 2, wherein inner dimensions of the holder-like container are adapted to receive close-fittingly therein at least one insert tray of standardized dimensions, and wherein the system further comprises the at least one insert tray.

24. The system of claim 2, wherein the growth substrate comprises:
a layer of particulate material on a bottom of the holder-like container;
a separating layer on the layer of particulate material; and
a growth layer positioned over the separating layer.
